(19) United States
(12) Patent Application Publication
(10) Pub. No.: US 2008/0078397 A1
(43) Pub. Date: Apr. 3, 2008

(54) HOSE SUPPORT SYSTEM

(76) Inventors: Ronald Scott, Janesville, WI (US); Daniel Christianson, Jefferson, WI (US)

Correspondence Address: MICHAEL BEST & FRIEDRICH LLP, ONE SOUTH PINCKNEY STREET, P O BOX 1806, MADISON, WI, 53701, US

(21) Appl. No.: 11/862,525

(22) Filed: Sep. 27, 2007

Related U.S. Application Data
(60) Provisional application No. 60/827,282, filed on Sep. 28, 2006.
(60) Provisional application No. 60/908,813, filed on Mar. 29, 2007.

(51) Int. Cl. A62B 27/00

(52) U.S. Cl. 128/205.25; 128/200.24; 248/75

(57) ABSTRACT

The present invention provides a hose support system that can be used to support hoses, tubes, wires, cables, etc., from medical devices. The invention comprises a base unit, a support arm and a flexible rod with fasteners attached. The base unit stabilizes the other connected components by placement under a mattress, a cushion or other weighted item next to both the medical device and the patient. At least one fastener is attached to the flexible rod to hold the line (i.e., hose, cable, wire, tube, etc.) from the medical device up off of the bed which allows delivery of the precise amount of the line needed.

### CROSS REFERENCE TO RELATED APPLICATIONS

The application claims priority to U.S. Provisional Patent Application No. 60/827,282 filed Sep. 28, 2006 and U.S. Provisional Patent Application No. 60/908,813 filed Mar. 29, 2007. These applications are incorporated by reference in their entirety.

### FIELD OF THE INVENTION

The present invention relates to a hose support system that can be used to support hoses or other wires, cables, etc., associated with medical devices. Suitably, the hose support system can be used to support the hose from a continuous positive airflow pressure (“CPAP”) device.

### BACKGROUND

CPAP machines are utilized in the treatment of sleep apnea. Sleep apnea occurs when the muscles in the throat relax and the throat eventually closes off. After 20 to 30 seconds the brain senses oxygen deprivation and brings the patient to a lower level of sleep in order to start breathing again. Consequently, patients with sleep apnea often do not get enough deep sleep which results in daytime sleepiness and often other more serious health problems.

A CPAP machine is a simple respiratory ventilator used mainly by patients in the home treatment of sleep apnea. The CPAP machine prevents a patient's throat muscles from closing off by delivering a constant stream of compressed air via a mask connected to a hose. As a result, patients with sleep apnea are able to get more deep sleep because they are no longer cycling through the episodes of oxygen deprivation resulting from the throat muscles closing off.

The CPAP machine usually sits next to the patient's bed and is connected to a hose. The hose is generally around six feet in length and attaches to a rotating connector on the mask. The arrangement of the mask and connected hose presents common problems for patients as they use the CPAP machine during sleep, including: rolling over onto a hard, cold hose; rolling over while on the hose and yanking it loose from the mask or pulling the machine itself from its placement; getting the hose tangled in the headgear, around one's pillow or around one's neck; overflow air blowing onto an arm, a shoulder or a bed partner; mask becoming displaced or dislodged due to movement with a tangled hose.

A solution is needed whereby the hose of the CPAP is suspended away from the patient using the CPAP, allowing the patient a full range of movement without getting tangled in the hose. Similarly, such a solution is needed for patients hooked up to other medical devices attaching cords, tubes, wires, etc., to a patient.

### SUMMARY OF THE INVENTION

The present invention provides a hose support system that can be used to support hoses, tubes, wires, cables, etc., from medical devices, such that a patient, particularly a patient in a bed, can have a full range of movement without getting tangled in the hoses, wires, cables, tubes, etc.

In one embodiment, the invention provides a hose support system comprising a base unit, a support arm and a flexible rod with fasteners attached. The support arm is connected to the base unit at one end and a movable joint portion at the other end. The movable joint has a receiving section for the flexible rod. The flexible rod is connected to the moveable joint by the receiving section. The base unit stabilizes the other connected components by placement under a mattress, a cushion or other weighted item next to both the medical device and the patient. Alternatively, the base unit may be built into or connected to a table or other base of a medical device that is situated near the patient. At least one fastener is attached to the flexible rod to hold the line (i.e., hose, cable, wire, tube, etc.) from the medical device up off of the bed which allows delivery of the precise amount of the line needed. The flexible rod extends over the patient's bed and is adjustable to a point above the patient's head so as to allow the line to hang down and not impede the patient's movements during sleep. When a hose delivering air is used (such as with a CPAP machine), this also helps to maintain a tight seal on the patient's mask attached to the hose. The hose support system can easily be assembled and disassembled without the use of tools, allowing the unit to be easily portable and easily stored.

In another embodiment, the invention provides a flexible air mask interface between a breathing mask and an air hose. The interface comprises a base and a flexible coupling cylinder connected to the base at one end and the air hose at another end. The base of the interface can be connected directly to a breathing mask, or can be connected to an elbow connection piece that is attached to a breathing mask. The base of the interface is designed in a way that is allows the base to rotate 360 degrees around the latitudinal axis of the base.

Other aspects of the invention will become apparent by consideration of the detailed description and accompanying drawings.

### BRIEF DESCRIPTION OF THE DRAWINGS

FIG. 1 is a perspective view of one embodiment of the hose support system shown secured in place under a bed, the hose support system including the base, support arm and flexible arm.

FIG. 2 is a partial perspective view of one embodiment of the hose support system shown secured in place under a bed, the hose support system including the base, support arm and flexible arm.

FIG. 3 is an exploded view of the support arm, the joint connecting cap, the joint connecting sleeve, and the moveable joint.

FIG. 4 is a close up view of the support arm and the joint connecting cap.

FIG. 5 is an exploded, partially cut-away view of the support arm, the joint connecting cap, the joint connecting sleeve, and the moveable joint.

FIG. 6 is an assembled cut-away view of the support arm, the joint connecting cap, the joint connecting sleeve, the moveable joint and the flexible arm.

FIG. 7 is a perspective view of the support arm, the joint connecting cap, the joint connecting sleeve, the moveable joint and the flexible arm.

FIG. 8 is a close up view of the flexible arm connectors in a connected configuration.

FIG. 9 is a close up view of the male and flexible arm connectors in an unconnected configuration.

FIG. 10 is a cut-away view of the flexible arm connectors in a connected configuration.

FIG. 11 is a perspective view of the base and support arm of the hose support system.

FIG. 12 is an exploded view of the base showing the base housing, the extended legs and the leg caps.

FIG. 13 is a perspective view of one embodiment of the hose support system shown secured in place under a bed, the hose support system including the base, support arm and flexible arm, with CPAP air hose being attached to the flexible arm.

FIG. 14 is a close up perspective view showing the CPAP air hose attached by the clips to the flexible arm.

FIG. 15 is a close up perspective view showing the CPAP air hose attached by the distal end clip to the flexible arm.

FIG. 16 is a close up of the end of the flexible arm with a distal end clip attaching the CPAP air hose to the flexible arm.

FIG. 17 is an exploded view of the air mask interface and the air mask.

FIG. 18 is a perspective view of the air mask interface connected directly to an air mask.

FIG. 19 is a top view of the air mask interface.

FIG. 20 is an exploded side view of the air mask interface.

FIG. 21 is a side view of a CPAP air hose attached to the flexible coupling cylinder of the air mask interface.

FIG. 22 is a side perspective view of an air mask attached to a connection elbow.

FIG. 23 is a side exploded view of an air mask attached to a connection elbow, a redirective connection elbow, the base on the flexible coupling cylinder of the air mask interface.

FIG. 24 is a side view of an air mask with a connection elbow attached to the redirective connection elbow attached to the air mask interface.

FIG. 25 is a side view of an air mask which is attached to another embodiment of an air mask interface comprising a first elbow connector which is attached to a second elbow connector.

FIG. 26 is a perspective view of an air mask which is attached in another embodiment of an air mask interface comprising a ball and socket interface.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. The use of the term “attached” is meant that the elements listed as attached to each other are either secured to each other, affixed to each other, attached to each other, or integral to each other (i.e., present in the same piece).

### DETAILED DESCRIPTION OF THE INVENTION

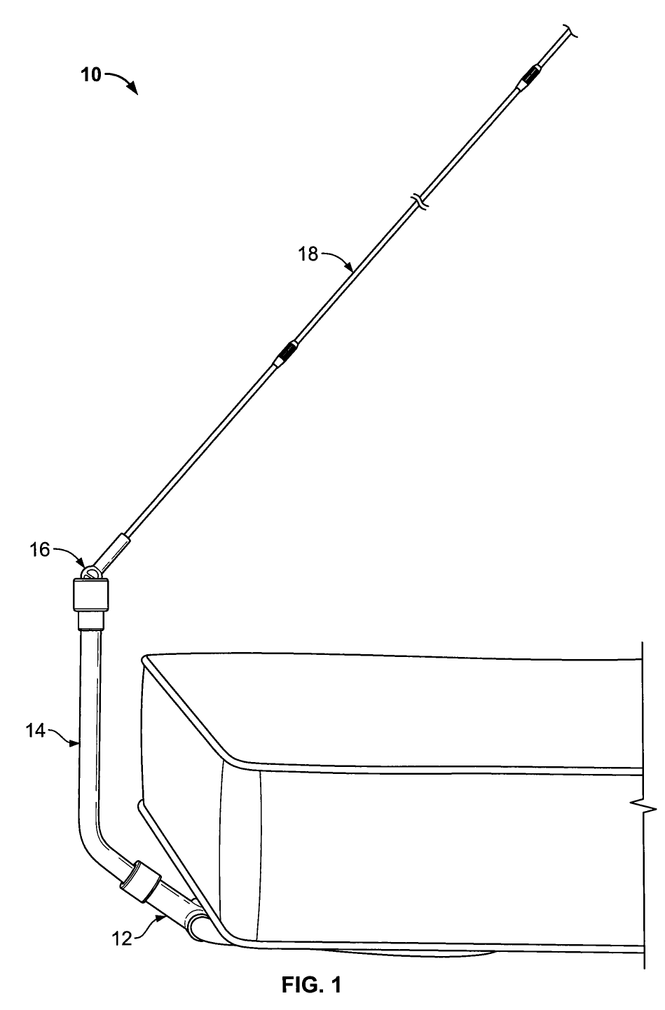

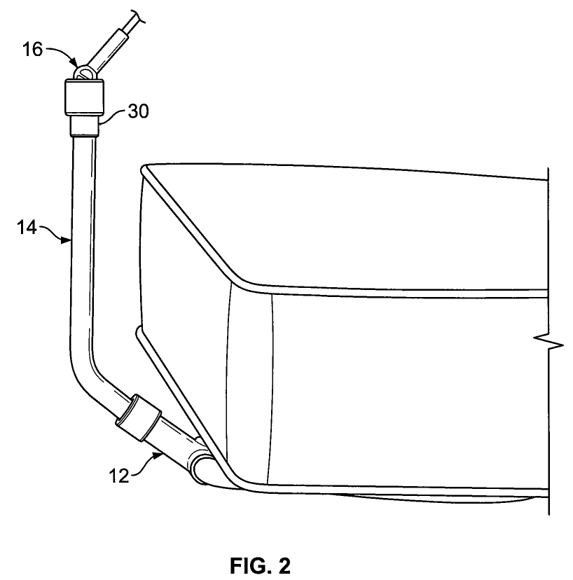

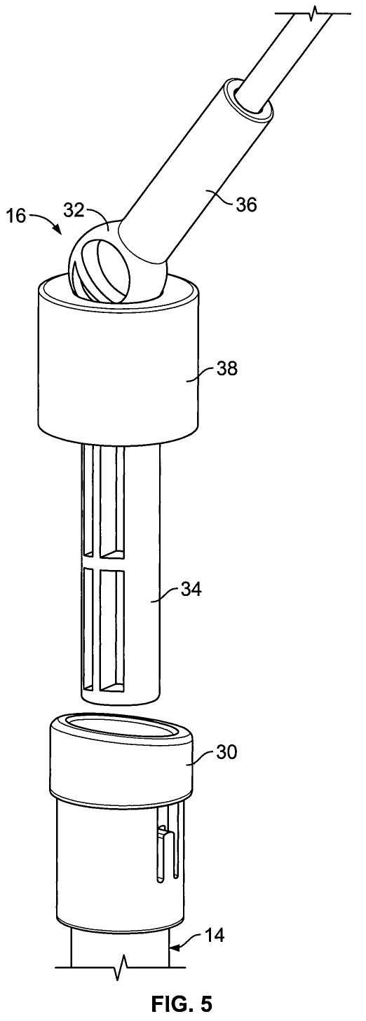

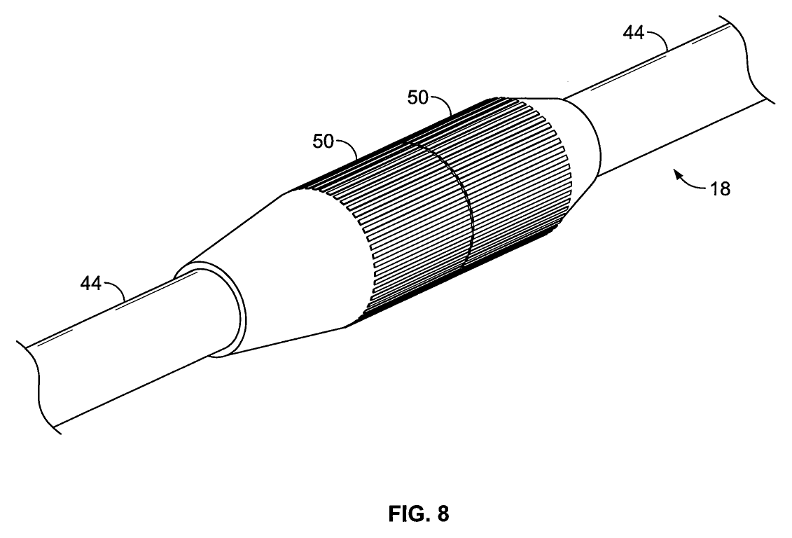

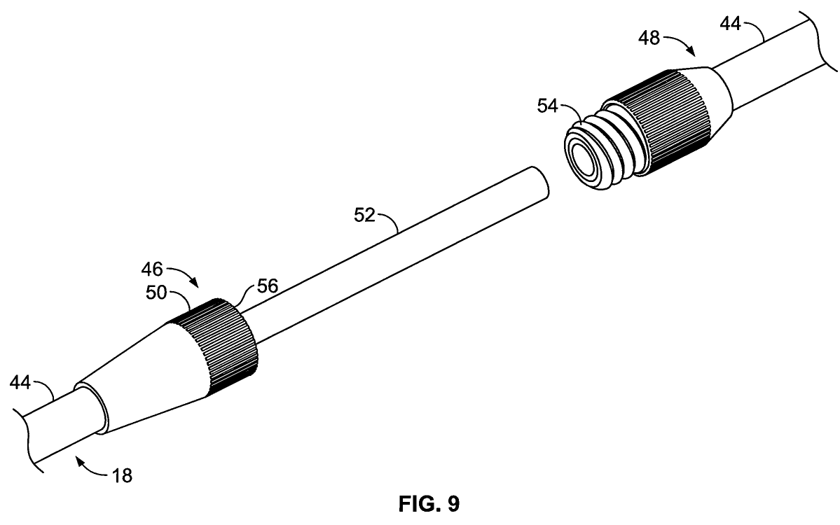

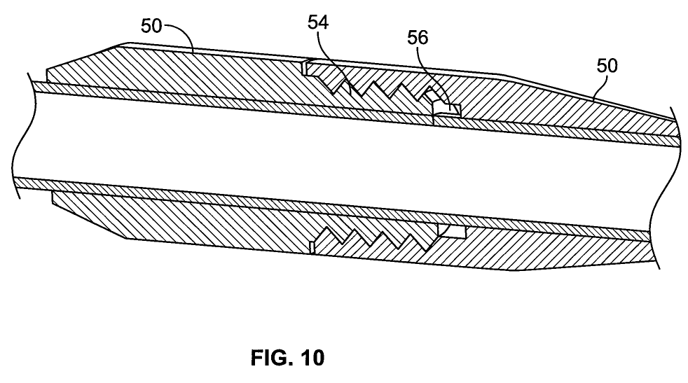

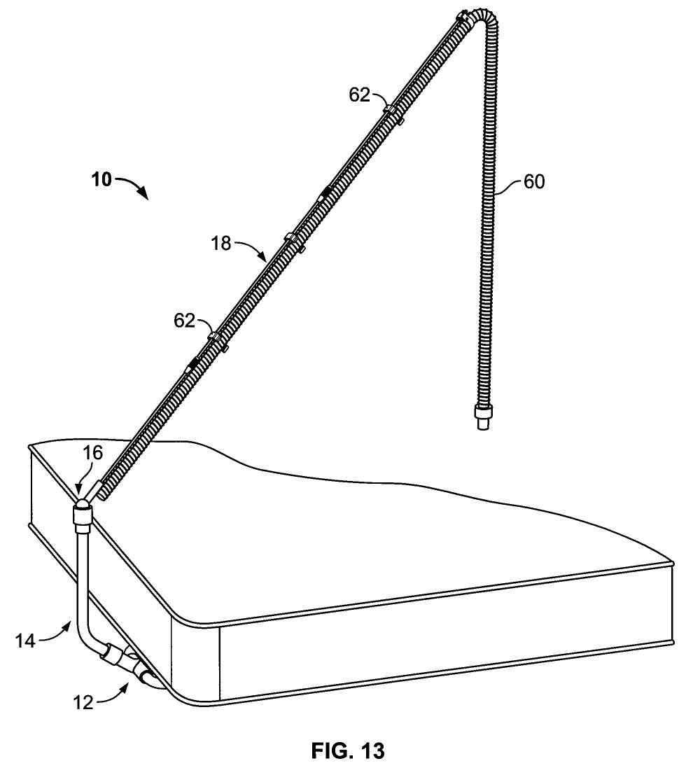

In one aspect, the present invention provides a hose support system that can be used to support hoses, tubes, wires, cables, etc., from medical devices. The hose support system is best show in FIGS. 1-17.

In one embodiment, the hose support system 10 comprises a base 12, support arm 14, a moveable joint 16, and a flexible arm 18.

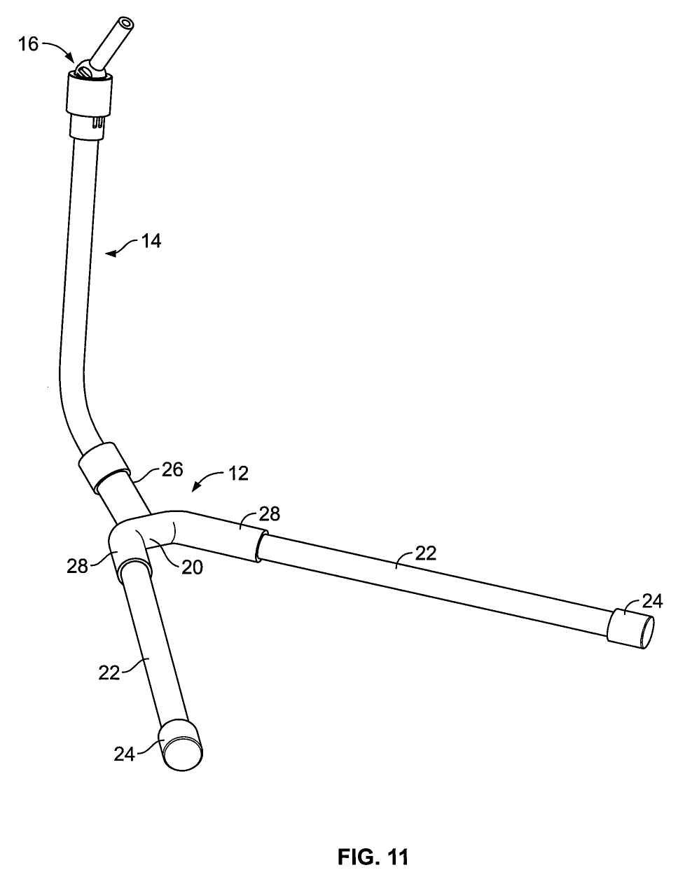

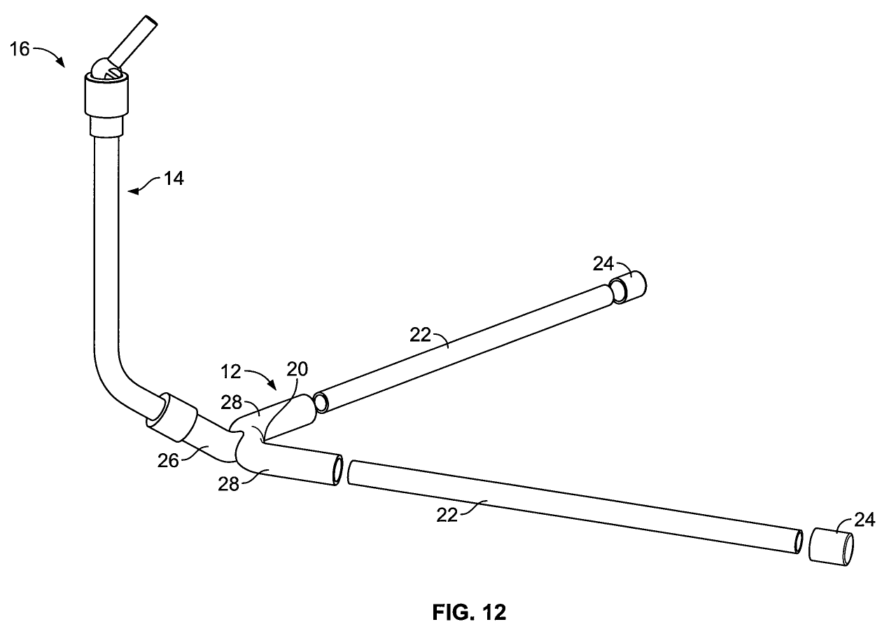

The base unit 12 consists of a housing connected to a leg unit for placing under a mattress that a patient lies on, and a central extension unit that is attached to a support arm. The leg section can be any structural arrangement that would provide support to the base unit 12. The leg section can be a flat board or panel arrangement or can consist of extended legs. One embodiment of the base 12 can be seen in FIGS. 11-12. In this embodiment the base 12 comprises a base housing 20, a pair of extended legs 22, and leg caps 24. The components of the base 12 can be made of any sturdy material, including but not limited to, plastic, metal, ceramics, or other composites. The base housing 20 has a central extension 26 which has an aperture to receive one end of the support arm 14, and two angled extensions 28, each angled extension having an aperture to receive an extended leg 22. The central extension 26 of the base unit can suitably be disposed at any angle with respect to the extended legs 22. The extended legs 22 are received by the angled extensions 28 on one end of the extended legs 22. The other end of the extended legs 22 can be capped by leg cap 24 sections. The extended legs 22 can be attached to the base housing 20 by a friction fit with the angled extensions 28. The extended legs 22 may alternatively be attached by way of any standard interlocking tab means, or may be screwed into the angled extensions 28 by a threaded arrangement. The leg caps 24 can also be attached to the extended legs 22 by a friction fit, standard interlocking tabs, a screwed threaded arrangement, or any other connection arrangement. When the hose support system 10 is being used, the extended legs 22 of the base 12 are placed between the mattress and box spring of the bed the patient is sleeping on. The leg caps 24 of the base 12 help aid the extended legs 22 from slipping out from the mattresses. Alternative embodiments may allow for the base of the delivery system to attach, for example but not limited to, a medical device, a table next to a patient's bed, the patient's headboard or the ceiling above the patient's bed.

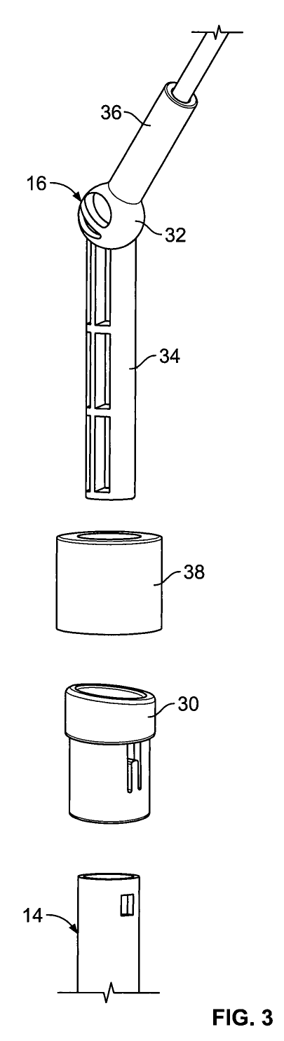

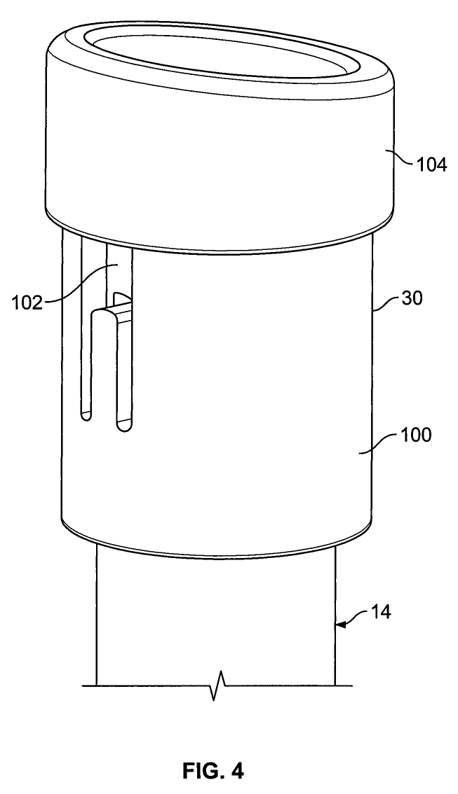

One end of the support arm 14 has a first and second end. The first end is received by the central extension 26 of the base housing 20. This connection, in one embodiment, can be a movable joint connection. The support arm can be made of any sturdy material such as plastic, metal, ceramics, or other composites. The second end of the support arm 14 is attached to the moveable joint 16. The arrangement is best shown in FIGS. 3-6. In one embodiment, the end of the support arm 14 is connected to a joint connecting cap tube 30. The joint connecting cap tube 30 has a sleeve section 100 having an inside 102 and a collar section 104. The support arm 14 is received by the inside 102 of the sleeve section 100. In one embodiment this connection can be a tab connection as shown in FIG. 4, or can be a friction fit, screwed threaded arrangement, or any other suitable connection.

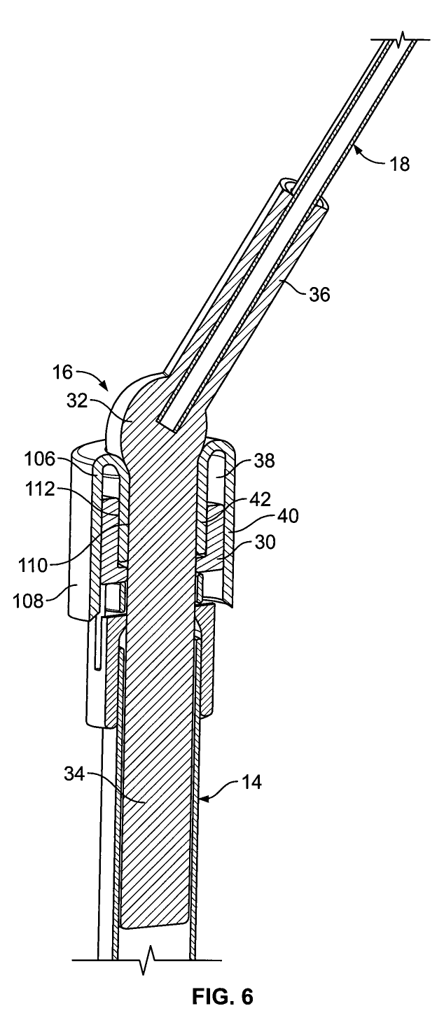

The movable joint portion 16 has a joint 32, a stem 34 and a flexible arm receiving section 36. In one embodiment, the stem 34 of the moveable joint 16 is secured to the support arm 14 by way of a joint connecting sleeve 38. This arrangement is best shown in FIG. 6. The joint connecting sleeve 38 has an outer collar 40 having an inside 106 and an outside 108, and an inner collar 42 having an inside 110 and an outside 112. The stem 34 of the movable joint 16 is received by the inside 106 of the inner collar 42 and an aperture in the support arm 14. A portion of the joint connecting cap 30 is captured between the outside 112 of the inner collar 42 and the inside 106 of the outer collar 40 of the joint connecting sleeve 38. In another arrangement, the stem 34 can be connected to the support arm 14 by a friction fit, a tabbed connection, a screwed threaded arrangement, or any other suitable connection. The stem could also, alternatively, be connected to the joint connection cap tube 30 or joint connecting sleeve 38 by any such arrangement. The movable joint portion 16 may be adjusted and moved to obtain an ideal position for hose delivery to the patient. The joint 32 may be a ball joint, a flexure joint, a spring joint or any other type of movable joint suitable to maximize the effectiveness of the hose delivery system.

The flexible arm receiving section 36 of the movable joint 16 is designed to receive and secure the flexible arm 18. Suitably, the flexible arm receiving section 36 allows for the detachment of the flexible arm 18 for ease of travel and storage. The flexible arm 18 can be connected to the arm receiving section 36 by a friction fit, standard interlocking tabs, a screwed threaded arrangement, or any other connection arrangement.

The flexible arm 18 can suitably be one piece, or consist of a number of pieces, allowing the flexible arm to be collapsible for easy portability. The flexible arm 18 is suitably made from any durable flexible material, such as plastic, graphite composites, or other suitable material. When the flexible arm 18 is comprised of multiple sections 44, the sections 44 may be inflexible, but connected by at least one flexible joint such that the multiple sections 44 are flexible relative to each other. At least one flexible joint may be made from any durable flexible material, such as plastic, graphite composites, or other suitable material. The flexible joint may include, but not be limited to, a ball and socket joint, a hinged joint, an accordion-fold joint, a spring-type joint, a swivel joint, or a pivot joint or any other suitable joint.

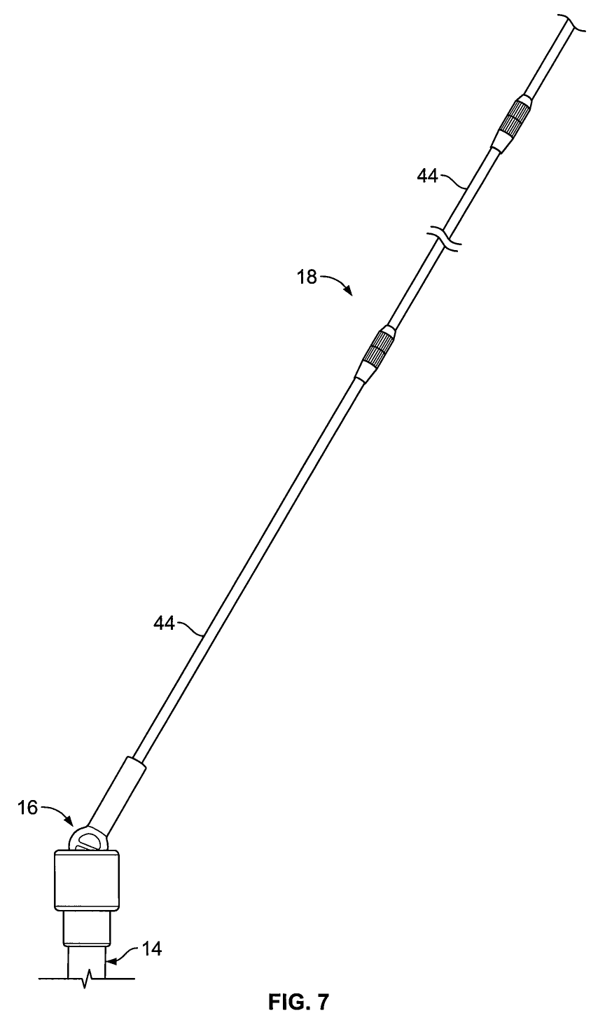

Alternatively, when the flexible arm 18 is comprised of multiple sections 44, the sections 44 can be connected by male 46 and female 48 connecting sections. This arrangement is best shown in FIGS. 7-10. The male connecting section 46 comprises a connection collar 50 and an elongated shaft 52. The female connection section 48 comprises a connection collar 50 that has a hollow portion that is designed to receive the elongated shaft 52 of the male connecting section 46. One of the connection collars 50 has a male threaded portion 54 and the other has a female threaded portion 56. These portions 54, 56 can be screwed together to connect the sections 44 of the flexible arm 18.

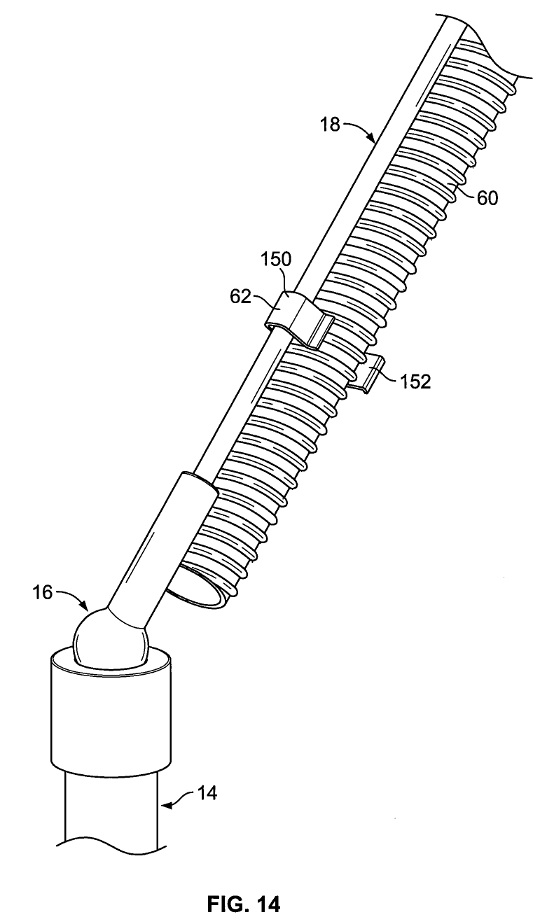

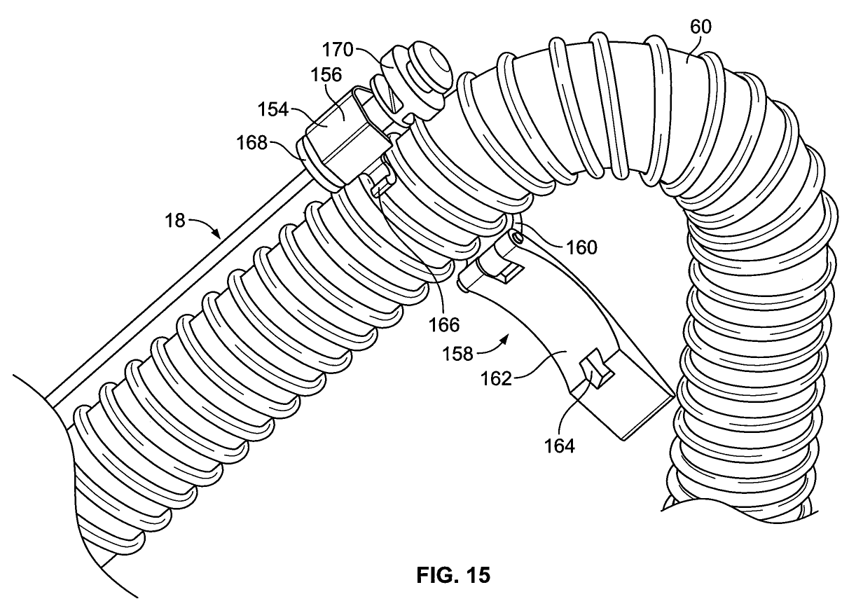

A hose 60 can be secured to the flexible arm 18 by means of clips 62. In one embodiment, as shown in FIG. 14, the clips 62 comprise an arm securing section 150, which receives a portion of the flexible arm 18, and a hose securing section 152 which clips to a portion of the hose 60. The fasteners of the flexible arm 18 can also include a distal end clip 154, as shown in FIGS. 15-16. The distal end clip 154 has an arm securing section 156 which receives a portion of the flexible arm 18. The distal end clip 154 also comprises a hose clamp section 158 which has a first hose receiving section 160 which is connected to the arm securing section 156 at one end and is hingedly connected to a second hose receiving section 162 on the other end. The second hose receiving section 162 has an aperture 164 designed to receive a tab 166 on the arm securing section 156 of the distal end clip 154. When the tab 166 is snapped into the aperture 164, the second hose receiving section can be locked into place around a portion of the hose 60. The distal end clip 164 is suitably positioned between an intermediate stopping section 168 and an end stopping section 170 of the flexible arm 18. This positioning stops the distal end clip 164 from sliding down the flexible arm 18. Alternatively, the hose 60 can be connected to the flexible arm 18 by any other suitable fastener means, including an enclosure that encircles the hose 60 that is closed by Velcro, a snap, an interlocking tab arrangement, or other suitable fastener arrangements. The flexible arm 18 holds the hose 60 off the bed and allows the hose 60 to slide through the clips 62 to constantly adjust to a patient's hose 60 needs.

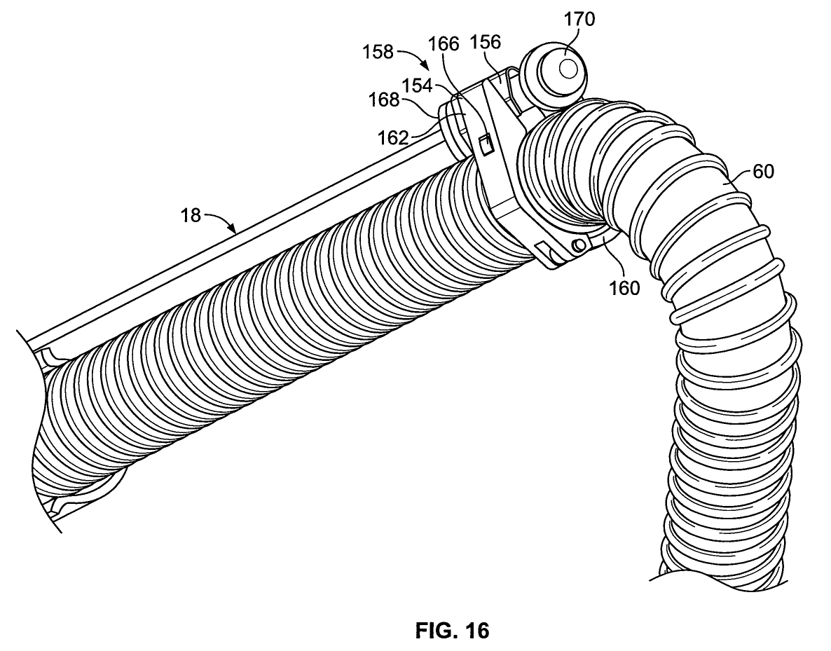

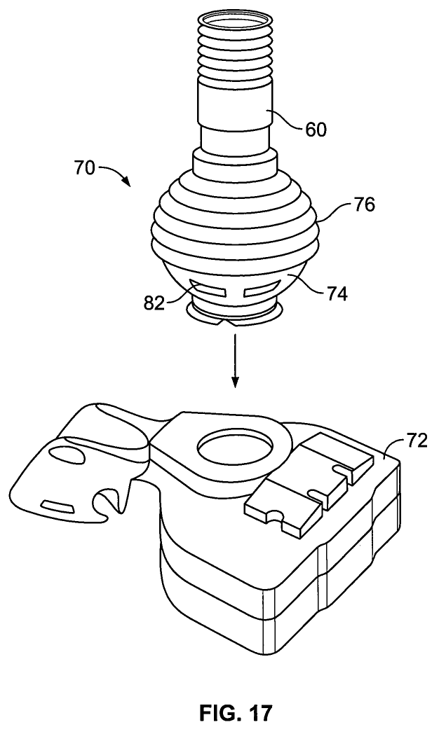

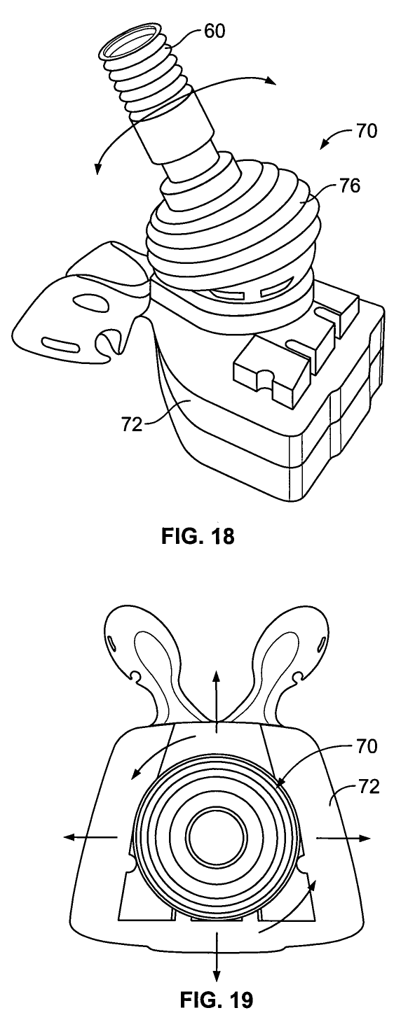

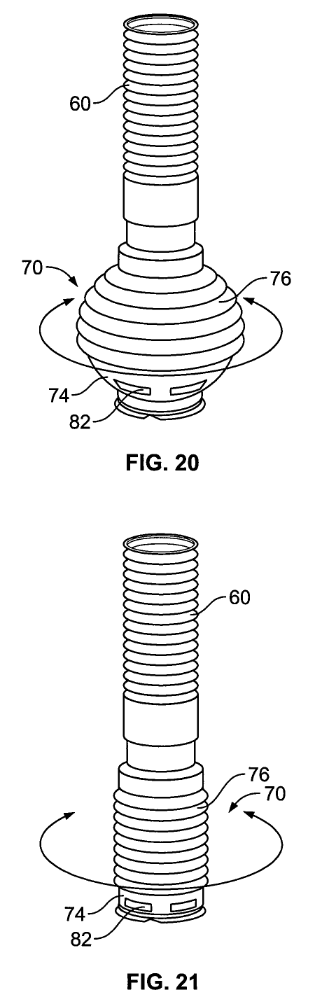

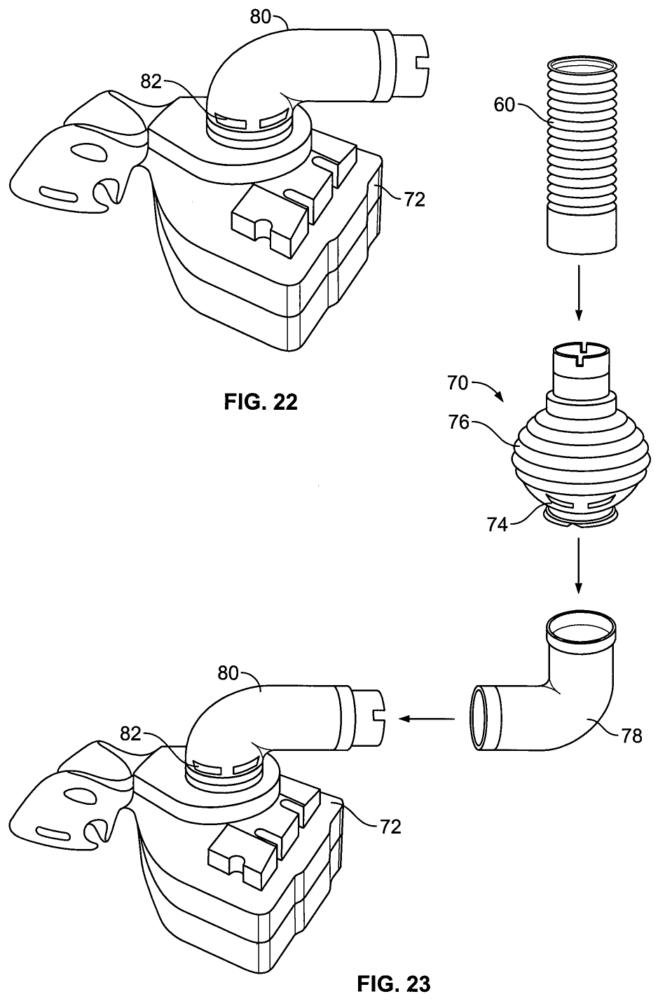

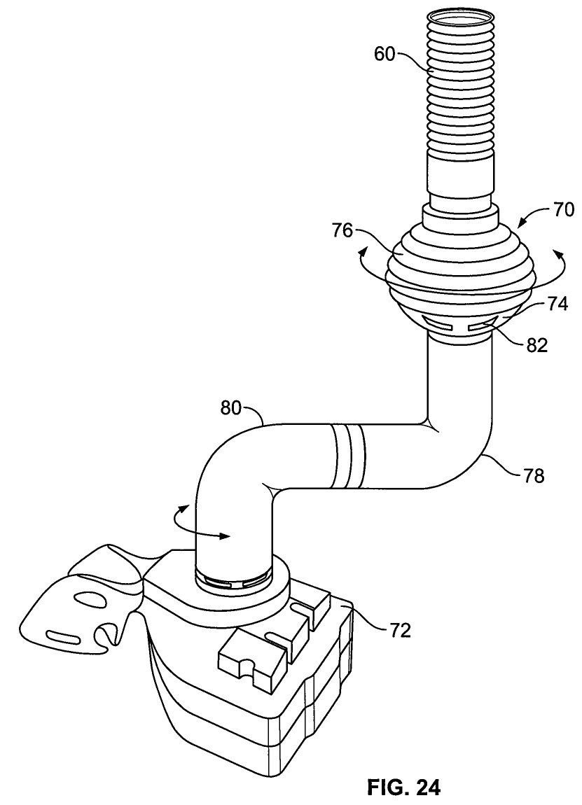

In another embodiment of the invention, the invention provides a flexible air mask interface 70 between a breathing mask 72 and an air hose 60. This aspect of the invention is best shown in FIGS. 17-24. The flexible air mask interface 70 comprises a base 74 and a flexible coupling cylinder 76 connected to the base 74 at one end and the air hose 60 at another end. The base 74 of the flexible air mask interface 70 can also have small holes 82 that allow excess air to escape. The flexible coupling cylinder 76 is made from flexible material, including but not limited to corrugated material, that allows the cylinder 76 to bend in any direction. The flexible cylinder 76 can be made from any diameter necessary for the desired flexibility. The base 74 is designed in a way that it can rotate 360 degrees around the latitudinal axis of the base.

In one embodiment, the base 74 of the interface can be connected directly to a breathing mask 72. In another embodiment the base 74 connects to a redirective connection elbow 78 that is connected to the standard connection elbow 80 of a breathing mask 72. The redirective connection elbow 78 can be made of any sturdy material such as plastic.

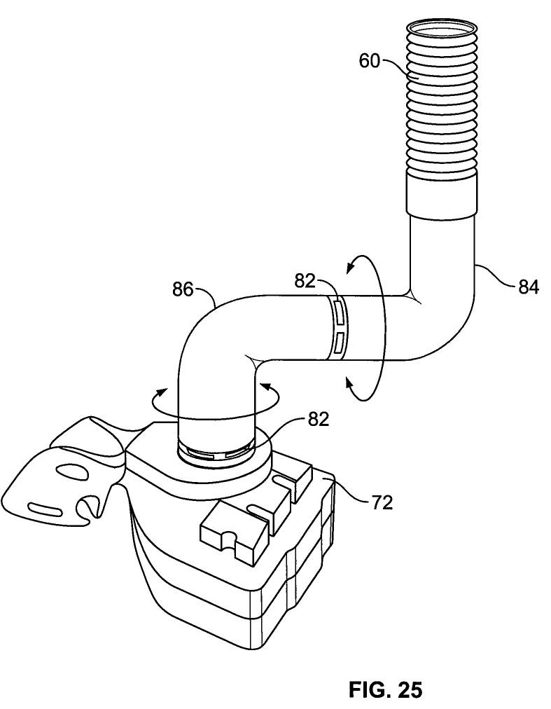

In another alternative embodiment shown in FIG. 25, the air mask interface can be comprised of at least two elbow connectors. A first elbow connector 84 is connected to an air hose 60 and a second elbow connector 86 is connected to the breathing mask 72. Each end of the elbow connectors 84, 86 can be rotationally connected to either each other, the air hose 60 and/or the breathing mask 72. Each elbow can provide 360 degrees of rotation in two dimensions, so that when they are attached to each other they provide 360 degrees of three dimensional rotation. This allows for the freedom for the breathing mask 72 to be moved without tangling the air hose 60.

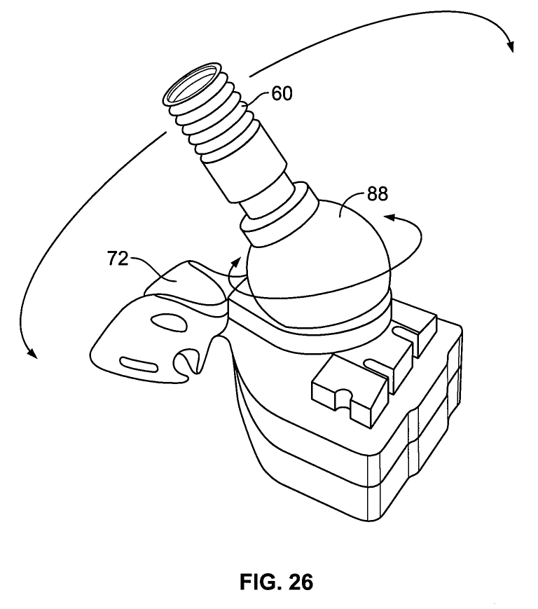

In yet another alternative embodiment shown in FIG. 26, the air mask interface can be comprised of a ball and socket interface 88 that is connected to an air hose 60 at one end and the breathing mask 72 at the other end. The ball and socket interface 88 allows for 360 degrees of three dimensional free rotation. This allows for the freedom for the breathing mask 72 to be moved without tangling the air hose 60.

When the flexible air mask interface 70 of the invention is used with the hose support system 10 of the present invention, the air hose 60 extends straight up from the air mask interface to the flexible arm 18 of the hose support system 10. In this arrangement, regardless of user movement in any direction, the air mask interface moves continuously to point in an upward direction, eliminating pull or drag caused by the pivot movement that is necessary when using a standard elbow connection 80. The flexibility and continuous upward pointing allows for a smooth, unnoticeable transition for the user when moving from one position to another.

Variations and modifications of the foregoing are within the scope of the present invention. It is understood that the invention disclosed and defined herein extends to all alternative combinations of two or more of the individual features mentioned or evident from the text and/or figures. All of these different combinations constitute various alternative aspects of the present invention. Various features and advantages of the invention are set forth in the following claims.

1. A hose support system comprising:
a base unit comprising a base housing having a central extension and a leg section;
a support arm having a first and second end, wherein the first end of the support arm is connected to the central extension;
a movable joint portion comprising a joint connected to a stem portion at one end and a flexible arm receiving section at another end; wherein the stem of the movable joint portion is connected to the second end of the support arm;
a flexible arm having a first and second end, wherein the first end of the flexible arm is received by the flexible arm receiving section movable joint portion; and
hose fasteners which are connected to the flexible arm.

2. The hose support system of claim 1 comprising a CPAP machine, wherein the air hose of the CPAP machine is secured to the flexible arm of the hose support system by the hose fasteners.

3. The hose support system of claim 1 wherein the support arm is connected to the central extension by a moveable joint.

4. The hose support system of claim 1 wherein the flexible arm consists of multiple pieces; at least one piece having a male connection section comprising a connection collar and an elongated shaft, and at least one piece having a female connection section comprising a connection collar having a hollow portion which receives the elongate shaft of the male connection section.

5. The hose support system of claim 1 wherein the flexible arm consists of multiple pieces, with at least two pieces connected to each other by a flexible joint.

6. The hose support system of claim 1 wherein the hose fasteners comprise at least one clip, wherein the clip comprises an arm securing section which receives a portion of the flexible arm and a hose securing section.

7. The hose support system of claim 1 wherein the hose fasteners comprise at least one distal end clip, wherein the distal end clip comprises an arm securing section and a hose clamp section having a first hose receiving section having two ends, wherein the first hose receiving section is connected to the arm securing section at one end and is hingedly connected to a second hose receiving section at the other end; and wherein the arm securing section of the distal end clip receives a portion of the flexible arm and is positioned between an intermediate stopping section and an end stopping section of the flexible arm.

8. A method of supporting an air hose of a CPAP device being used by a patient comprising:
providing a CPAP device with an air hose;
providing an air hose support system of claim 1:
positioning the leg section of the hose support system under a mattress where the patient will be sleeping; and
securing the air hose of the CPAP machine to the flexible arm of the hose support system by the hose fasteners.

9. A hose support system comprising:
a base unit comprising a base housing having a central extension having an aperture and a first and second angled extensions each having an aperture;
a first extending leg section which is received by the aperture of the first angled extension and a second extending leg section which is received by the aperture of the second angled extension;
a support arm having a first and second end, the second end having an aperture, wherein the first end of the support arm is received by the aperture of the central extension;
a joint connecting cap tube having a sleeve section having an inside and a collar section; wherein the second end of the support arm is received by the inside of the sleeve section of the joint connecting cap;
a movable joint portion comprising a joint connected to a stem portion at one end and a flexible arm receiving section at another end;
a joint connection sleeve, wherein the joint connection sleeve has an outer collar having an inside and an outside and an inner collar having an inside and an outside; wherein the stem of the movable joint portion is received by the inside of the inner collar of the joint connection sleeve and the aperture of the second end of the support arm; wherein the collar section of the joint connecting cap is received between the outside of the inner collar of the joint connection sleeve and the inside of the outer collar of the joint connection sleeve;
a flexible arm having a first and second end, wherein the first end of the flexible arm is received by the flexible arm receiving section movable joint portion; and
a hose fastener which is connected to the flexible arm.

10. The hose support system of claim 9 comprising a CPAP machine, wherein the air hose of the CPAP machine is secured to the flexible arm of the hose support system by the hose fasteners.

11. The hose support system of claim 9 wherein the flexible arm consists of multiple pieces; at least one piece having a male connection section comprising a connection collar and an elongated shaft, and at least one piece having a female connection section comprising a connection collar having a hollow portion which receives the elongate shaft of the male connection section.

12. The hose support system of claim 9 wherein the flexible arm consists of multiple pieces, with at least two pieces connected to each other by a flexible joint.

13. The hose support system of claim 9 wherein the hose fastener comprises a clip, wherein the clip comprises an arm securing section which receives a portion of the flexible arm and a hose securing section.

14. The hose support system of claim 9 wherein the support system further comprises a distal end clip, wherein the distal end clip comprises an arm securing section and a hose clamp section having a first hose receiving section having two ends, wherein the first hose receiving section is connected to the arm securing section at one end and is hingedly connected to a second hose receiving section at the other end; and wherein the arm securing section of the distal end clip receives a portion of the flexible arm and is positioned between an intermediate stopping section and an end stopping section of the flexible arm.

15. A method of supporting an air hose of a CPAP device being used by a patient comprising:
providing a CPAP device with an air hose;
providing an air hose support system of claim 9:
positioning the first and second extending legs of the hose support system under a mattress where the patient will be sleeping; and
securing the air hose of the CPAP machine to the flexible arm of the hose support system by the hose fasteners.

16. A flexible air mask interface providing an interface between a breathing mask and an air hose comprising:
a flexible tube base having sidewalls, a first end, a second end and a latitudinal axis, wherein the first end of the flexible tube base is connected to the breathing mask such that the flexible tube base can rotate 360 degrees around the base's latitudinal axis; and
a flexible coupling cylinder having sidewalls, a first and second end, wherein the first end of the flexible coupling cylinder is connected to the air hose and the second end of the flexible coupling cylinder is connected to the second end of the flexible tube base.

17. The flexible air mask interface of claim 16, wherein the air hose is connected to a CPAP machine, and the air hose of the CPAP machine is secured to a flexible arm of a hose support system by hose fasteners, the hose support system comprising:
a base unit comprising a base housing having a central extension and a leg section;
a support arm having a first and second end, wherein the first end of the support arm is connected to the central extension;
a movable joint portion comprising a joint connected to a stem portion at one end and a flexible arm receiving section at another end; wherein the stem of the movable joint portion is connected to the second end of the support arm;
the flexible arm having a first and second end, wherein the first end of the flexible arm is received by the flexible arm receiving section movable joint portion; and
wherein the hose fasteners are connected to the flexible arm.

18. The flexible air mask interface of claim 16 wherein the sidewalls of the flexible tube base have an aperture to allow air to flow through.

19. The flexible air mask interface of claim 16 wherein the sidewalls of the flexible coupling cylinder have an aperture to allow air to flow through.

20. A flexible air mask interface providing an interface between a breathing mask and an air hose comprising:
a first redirective connection elbow tube having sidewalls, a first end and a second end, the first end connected to the breathing mask; and
a second redirective connection elbow tube having sidewalls, a first end and a second end, the first end connected to the air hose and the second end of the second redirective connection elbow tube being connected to the second end of the first redirective connection elbow tube.

21. The flexible air mask interface of claim 20 wherein the air hose is connected to a CPAP machine, and the air hose of the CPAP machine is secured to a flexible arm of a hose support system by hose fasteners, the hose support system comprising:
a base unit comprising a base housing having a central extension and a leg section;
a support arm having a first and second end, wherein the first end of the support arm is connected to the central extension;
a movable joint portion comprising a joint connected to a stem portion at one end and a flexible arm receiving section at another end; wherein the stem of the movable joint portion is connected to the second end of the support arm;
the flexible arm having a first and second end, wherein the first end of the flexible arm is received by the flexible arm receiving section movable joint portion; and
wherein the hose fasteners are connected to the flexible arm.

22. The flexible air mask interface of claim 20 wherein the sidewalls of the first redirective connection elbow tube have an aperture to allow air to flow through.

23. The flexible air mask interface of claim 20 wherein the sidewalls of the second redirective connection elbow tube have an aperture to allow air to flow through.

24. A flexible air mask interface providing an interface between a breathing mask and an air hose comprising:
a redirective connection elbow tube having sidewalls, a first end and a second end, the first end connected to the breathing mask;
a second redirective connection elbow tube having sidewalls, a first end and a second end, the second end of the second redirective connection elbow tube being connected to the second end of the first redirective connection elbow tube;
a flexible tube base having sidewalls, a first end, a second end and a latitudinal axis, wherein the first end of the flexible tube base is connected to the second redirective connection elbow tube; and
a flexible coupling cylinder having sidewalls, a first and second end, wherein the first end of the flexible coupling cylinder is connected to the air hose and the second end of the flexible coupling cylinder is connected to the second end of the flexible tube base.

25. The flexible air mask interface of claim 24 wherein the air hose is connected to a CPAP machine, and the air hose of the CPAP machine is secured to a flexible arm of a hose support system by hose fasteners, the hose support system comprising:
a base unit comprising a base housing having a central extension and a leg section;
a support arm having a first and second end, wherein the first end of the support arm is connected to the central extension;
a movable joint portion comprising a joint connected to a stem portion at one end and a flexible arm receiving section at another end; wherein the stem of the movable joint portion is connected to the second end of the support arm;
the flexible arm having a first and second end, wherein the first end of the flexible arm is received by the flexible arm receiving section movable joint portion; and
wherein the hose fasteners are connected to the flexible arm.

26. A flexible air mask interface providing an interface between a breathing mask and an air hose comprising a ball and socket air mask interface which operatively connects the breathing mask and air hose so as to allow the passage of air from the air hose to the breathing mask.

27. The flexible air mask interface of claim 26 wherein the air hose is connected to a CPAP machine, and the air hose of the CPAP machine is secured to a flexible arm of a hose support system by hose fasteners, the hose support system comprising:
a base unit comprising a base housing having a central extension and a leg section;
a support arm having a first and second end, wherein the first end of the support arm is connected to the central extension;
a movable joint portion comprising a joint connected to a stem portion at one end and a flexible arm receiving section at another end; wherein the stem of the movable joint portion is connected to the second end of the support arm;
the flexible arm having a first and second end, wherein the first end of the flexible arm is received by the flexible arm receiving section movable joint portion; and
wherein the hose fasteners are connected to the flexible arm.
